(19) United States
(12) Patent Application Publication
(10) Pub. No.: US 2009/0175135 A1
(43) Pub. Date: Jul. 9, 2009

(54) INTEGRATED WATCH BAND AND METHODS THEREFOR

(75) Inventors: Christopher S. Moore, Wilmington, DE (US); Debra Forstenzer, New York, NY (US); Florian Strasser, Mainisberg (CH)

Correspondence Address: FERENCE & ASSOCIATES LLC, 409 BROAD STREET, PITTSBURGH, PA, 15143, US

(73) Assignee: Movado LLC, a limited liability company, Wilmington, DE (US)

(21) Appl. No.: 12/262,878

(22) Filed: Oct. 31, 2008

Related U.S. Application Data
(60) Provisional application No. 60/984,333, filed on Oct. 31, 2007.

(51) Int. Cl. G04B 37/18; A44C 5/00; B29C 45/14

(52) U.S. Cl. 368/282; 264/257

(57) ABSTRACT

The present invention includes an integrated (composite) watchband and process for making a watchband that integrates a high tensile strength fabric (e.g. an aramid fabric) within the watchband via an injection molding process. The resultant integrated watchband exhibits greatly increased strength while maintaining all the necessary characteristics of a conventional band.

### CLAIM FOR PRIORITY

This application claims priority from U.S. Provisional Patent Application Ser. No. 60/984,333, filed on Oct. 31, 2007 and which is incorporated by reference as if fully set forth herein.

### FIELD OF THE INVENTION

The invention pertains to an improved watchstrap or similar band exhibiting improved strength and methods for production thereof.

### BACKGROUND OF THE INVENTION

Conventional watchstraps and the like are made of various materials or combinations of materials, including metals, rubber, cloth, leather, etc. Each material or combination of materials used for watchbands and the like in the past has its own unique advantages and drawbacks.

While woven carbon fibers, aramid fibers/fabrics such as Kevlar® (a Registered Trademark of E. I. du Pont de Nemours and Company) and the like have been used in conventional ways for a variety of industrial applications, these materials have not been utilized in making an integrated watchband composite.

It has heretofore not been possible to incorporate materials having greatly increased strength, such as aramid fibers/fabrics, into integrated composite watchbands and the like due to several difficulties, including at least the appearance and workability of such fibers/fabrics/materials. Therefore, a need exists to address the shortcomings of conventional arrangements, as noted above.

### SUMMARY OF THE INVENTION

The present invention provides an integrated (composite) band suitable for use in watches and the like. The integrated band exhibits increased strength without sacrificing aesthetic quality or flexibility by integrating an aramid fabric into the band. An elastomer resin over-molding forms a monolithic composite having aramid fabric therein. The composite formation is facilitated by resin flowing around interstices of the woven aramid fabric. The benefits of this composite structure include at least inclusion of the woven fabric inside of the elastomer, protecting the fabric from chemical damage, ultraviolet (UV) damage, physical depletion (pull out of fibers), abrasion, and providing increased tensile break strength over elastomer alone.

In summary, one aspect of the invention provides an integrated band comprising: a polymer resin; and a high tensile strength fabric; wherein the high tensile strength fabric is integrally bonded within the polymer resin to form the integrated band.

Another aspect of the invention provides a method of forming an integrated band comprising: providing a high tensile strength fabric within a mold; injecting a polymer resin about the high tensile strength fabric; and curing the polymer resin and the high tensile strength fabric mixture; wherein the high tensile strength is integrally bonded within the polymer resin via the curing.

Another aspect of the invention provides a watch comprising: a watch case portion; and at least one integrated band portion comprising: a pin and hinge portion; a polymer resin; and a high tensile strength fabric; wherein the high tensile strength fabric is integrally bonded within the polymer resin; and wherein the polymer resin is molded about the pin and hinge portion to provide secure connection between the at least one integrated band portion and the watch case portion.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 provides views of a watch and watchstrap according to one embodiment of the instant invention.

FIG. 2 ((a)-(d)) includes views of a watchstrap according to an embodiment of the instant invention.

FIG. 3 ((a)-(h)) shows a hinging device for attaching a watchstrap and a watchcase according to an embodiment of the instant invention.

FIG. 4 illustrates a strip of aramid fabric material integrated into a watchstrap according to one embodiment of the invention.

FIG. 5 outlines information about a presently preferred aramid fabric material.

FIG. 6 provides a PSI graph of thermoresin band with and without aramid fabric.

FIG. 7 provides a weight/area strength graph of a band with and without aramid fabric reinforcement.

FIG. 8 provides a % strength graph of a band with and without aramid fabric reinforcement.

FIG. 9 provides a PSI graph of a band with and without aramid fabric reinforcement.

FIG. 10 provides a weight/area strength graph of a thermoresin band with and without aramid fabric.

### DETAILED DESCRIPTION OF THE PREFERRED EMBODIMENTS

For a better understanding of the present invention, together with other and further features and advantages thereof, reference is made to the following description, taken in conjunction with the accompanying drawings, and the scope of the invention will be pointed out in the appended claims.

It will be readily understood that the components of the present invention, as generally described and illustrated in the figures herein, may be arranged and designed in a wide variety of different configurations. Thus, the following more detailed description of the embodiments of the apparatus and method of the present invention, as represented in the figures, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings. The following description is intended only by way of example, and simply illustrates certain selected presently preferred embodiments of apparatuses and processes that are consistent with the invention as claimed herein.

The following description begins with a more general overview and then provides detailed description of presently preferred embodiments of the instant invention. Reference to the figures is made throughout the remainder of the description.

One embodiment of the present invention incorporates a high tensile strength fabric (e.g. aramid fabric (containing para-aramid fiber)) into an integrated composite watchstrap. Aramid fabric is used in various applications other than composite watchbands. Some useful background information on aramid fibers can be found at:

http://materials.globalspec.com/LearnMore/Materials_Chemicals₁₃ Adhesives/Composites_Textiles_Reinforcements/Aramid_Fiber_Aramid_Fabrics and is summarized below.

Aramid fiber and aramid fabrics consist of, inter alia, woven cloth forms of aromatic polyamide thermoplastic for reinforcing polymer matrix composites and other applications. A textile fabric made of aramid fibers is typically stronger. Aramid is made from an aromatic polymer that has a carbon-based backbone. Aramid fibers and aramid fabrics are created by spinning a solid fiber from the liquid polymer.

Aramid fabrics are frequently used in fire resistant clothing, protective equipment, asbestos mitigation equipment, etc. Aramid fabric can be treated with resins or epoxies to make polymer matrix composites. These composites combine the strength of the aramid fibers with the resin to create an industrial textile. These composites are frequently used in transportation applications, e.g. boats and aircraft.

Aramid fabrics are used to produce all kinds of synthetic materials, for example, fabrics for filtration, anti-static applications, plastic coverings, and medical products. Synthetic materials made of aramid fibers resist heat changes (e.g. melting). Aramid fibers and fabrics are also lightweight and flexible, making them useful in sporting goods such as skis. Aramid fabrics are also good insulators of electricity, are resistant to organic solvents, etc. Aramid fibers have a high tensile strength. However, aramid fabrics have not heretofore been incorporated into composite watchbands and the like at least because the fabrics are very difficult to cut and work with and have an unsuitable aesthetic appearance.

According to one embodiment of the instant invention, a unique, extremely strong integrated composite watchband is provided. A polymer resin watchband is provided with aramid fabric reinforcement. As a non-limiting example, a first side of the watchband is injection molded. Thereafter, a narrow, preformed aramid fabric strip is placed in a cavity within the first side of the injection-molded watchband. A second side of the watchband is then injection molded to form an integrated watchband having greatly increased strength, containing the aramid fabric therein. The polymer resin is allowed to cure, wherein the polymer changes its physical state from liquid to solid.

Aramid fabric comes in various forms. A presently preferred form is Kevlar®. Background information on Kevlar® can be found at:

http://www2.dupont.com/Kevlar/en_US/tech_info/index.html.

Vendors provide suitable aramid fabric, such as Berwick Offray LLC:

http://www.offray.com.

However, other vendors also supply suitable aramid fabric (e.g. Teijin Industries, Japan). The aramid fabric is provided within the polymer resin watchband so as to form an integrated watchband with greater strength while maintaining flexibility and ascetic quality suitable for use in watches and other jewelry.

It should be noted that while the remainder of the description provided herein is directed towards embodiments containing Kevlar®, other aramid fabrics (or other materials having similar properties) are suitable for use and can be utilized without departing from the scope or spirit of the invention.

A particular “open weave” aramid fabric is utilized such that the fabric can be adhered to the watchband substrate in a suitable way (e.g. by gluing the fabric into place within a cavity formed within the watchband substrate) and allow permeation (penetration or encapsulation) of the substrate material (e.g. Alcryn® MPR™ (melt processable rubber (MPR)) (a registered trademark of Ferro Corporation)) around the fibers of the aramid fabric. Pre-fabrication of the aramid fabric enables it to be suitable for use in a process for making, e.g. watchbands, as it will be of the proper size, thickness, weave, etc. for placement within the watchband substrate.

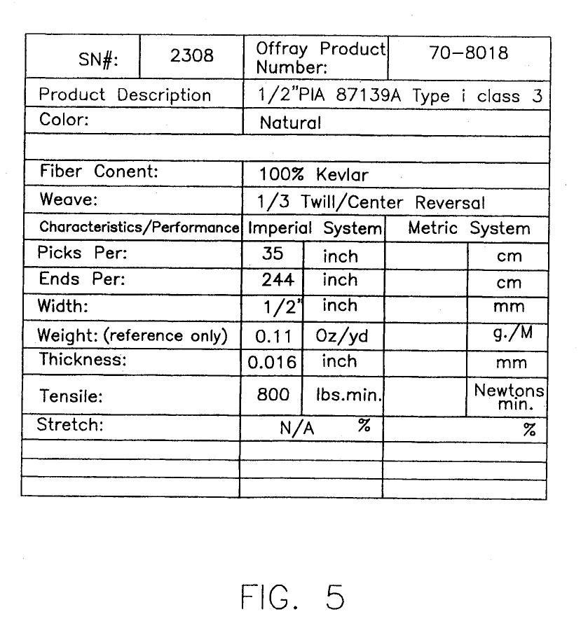

For example, aramid fabric is particularly difficult to cut once formed; thus, the fabric is preferably created/woven in a size suitable for use within the watchband substrate. Particularly suited for this use are Kevlar® “narrows” which are available from a manufacturers, for example Berwick Offray LLC (i.e. Specialty Narrow Fabrics®, a Registered Trademark of C. M. Offray & Son Incorporated, see FIG. 5). Such “narrows” also must be cleanly formed at the edges so as to avoid any formation of burrs at the edges. These burrs, if allowed to form, will interfere with the injection molding process for creating the integrated watchband (as described below).

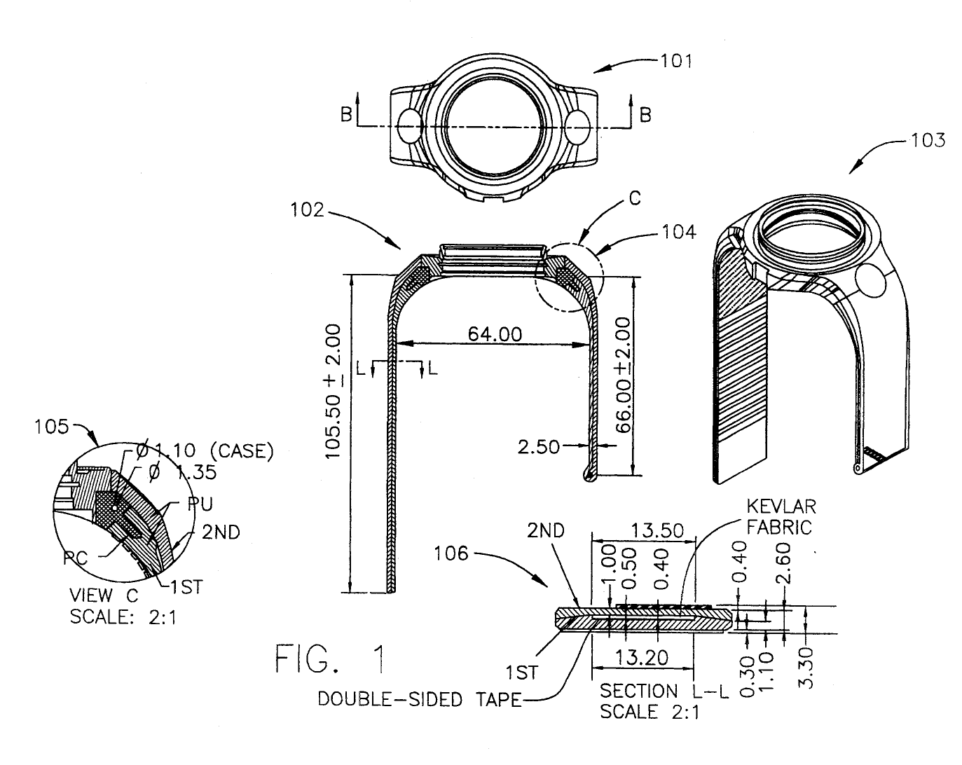

Referring now to the figures, FIG. 1 includes a top view (101), side view (102) and perspective view (103) of a watchstrap according to one embodiment of the instant invention. The side view of the strap includes a cross-sectional view (104) showing its integration into the case including additional close-up cross sectional views (105) (106). The case may be, for example, a steel case that integrates a strap into it or an extreme resin strap that has a combination of Alcryn® MPR™ and Kevlar® fabric, as shown in the top view on the side view (104) (at center).

It will be readily understood by those having skill in the art that the strap substrate may be formed from a variety of materials suitable for injection molding, including Alcryn® MPR™, polyurethane, thermoplastic elastomers (e.g. a thermoplastic elastomer with fully polymerized shore hardness between 45 A to 55 D) or the like. Additional information on Alcryn® MPR™, a presently preferred substrate, is available at:

http://www.apainfo.com/product_family/alcryn_mpr/Alcryn.html.

The side view cross-section (102) shows an integration of the case and bracelet (104) where the Kevlar® fabric or material is visible as running through the strap. In (106) a cross-section of the strap is shown where the Kevlar® fabric or material is again visible as running through the strap. A further close up cross sectional view of the attachment to the case is also present at (105). This view shows Kevlar® fabric and the various layered portions of the strap surrounding it. View (106) points out a double-sided adhesive tape portion (optional) adhering the Kevlar® fabric to a substrate base layer material for stabilization during injection molding. A top layer of substrate material covers the Kevlar® fabric.

Adhesive (e.g. the polymer resin itself, glue or tape) keeps the Kevlar® fabric in place during the injection of the upper substrate layer. The Kevlar® fabric could be adhered in other ways, however a resin (e.g. polyurethane) which acts as an adhesive and is reactive results in a stronger bond of the fabric to the surrounding substrate polymer resin. It should also be noted that a polyurethane liquid adhesive resin using, e.g. a similar hard and soft segment construction with a high NCO (isocyanate-urethane reactive unit) index, helps to bond multiple layers of polyurethane together during molding and renders the multi-layer device into one monolithic, reactively bonded composite.

The adhesive, whether resin, tape or glue, etc., holds the Kevlar® fabric, which may be in strip form, in place on a bottom substrate layer during an injection process where the upper substrate layer is injected over the Kevlar® strip to encase and/or immobilize the strip and create the integrated strap structure.

It should be noted that the woven fabric, having a bulk density less than the polymer from which it is made, has air spaces that serve as resin flow channels through the woven structure. Liquid and/or molten polymer resins can pass around the fibers and permeate through these channels, rendering a finished molding that is bonded fully around the reinforcing fabric—thus one integrated watchband results. This creates a composite with higher tensile strength than the resin alone.

It should also be noted that use of a low or room temperature reactive liquid resin system can be utilized to make the parts of the strap as well as the above described molten thermoplastic, higher pressure injection molding. This system was used to create prototypes for rupture strength testing (discussed below) and utilized a 70 A-80 A shore hardness polyurethane. It will be appreciated by those with skill in the art that woven, semi-woven, or non-woven fabrics may be utilized based on the desired amount of open space in the weave for various applications/conditions; woven fabric having substantial open spaces is presently preferred to enhance substrate material bonding and integration of the band.

According to one embodiment of the instant invention, the Kevlar® material used in the strip may have a fabric weave which provides interstices through which the upper substrate layer injection can permeate while still in its molten or liquid state, and serve to better fixate the Kevlar® strip to the lower substrate layer. Information about a presently preferred Kevlar® material is included in the materials submitted herewith (FIG. 5).

FIG. 1 introduces how the Kevlar® is integrated into the strap in a very unique use of Kevlar® material, not used or designed heretofore in the watch industry. The bottom cross sectional figure (106) shows that there are two pieces of substrate, the double-sided tape and the Kevlar® fabric in the watchband. The substrate pieces are applied by an injection process, which preferably fixes the Kevlar® material between an upper and a lower substrate layer.

It should be noted that an injection process can also be used in which the substrate pieces and the Kevlar® material are all injected together. As a non-limiting example, fine cut fibers (not woven but mixed like fiberglass in concrete) of Kevlar® or carbon fiber could be utilized. The high strength fibers in the resin are incorporated through molten mixing or compounding to form an injection moldable substance, in a one step injection method that gives improved break strength and cut and tear resistance without the need for woven or fabric insert. The substrate material may also be injected to surround the reinforcing fabric. The final result is an integrated band having an aramid fabric therein.

The use of Kevlar® material imparts strength and resilience to the strap/band and could result in a strap in the range of about eight times as strong as a traditional strap (whether this may be a leather or a resin strap) and significant improved tear resistance. Since the Kevlar® material and substrate layers are prepared by an injection process which forms a reinforced integral strap structure, the increase in strength and tear resistance is independent of the binding strength of any adhesive used, such as the double sided tape, which holds the Kevlar® material to the bottom substrate layer for purposes of fixation during the injection of substrate layers.

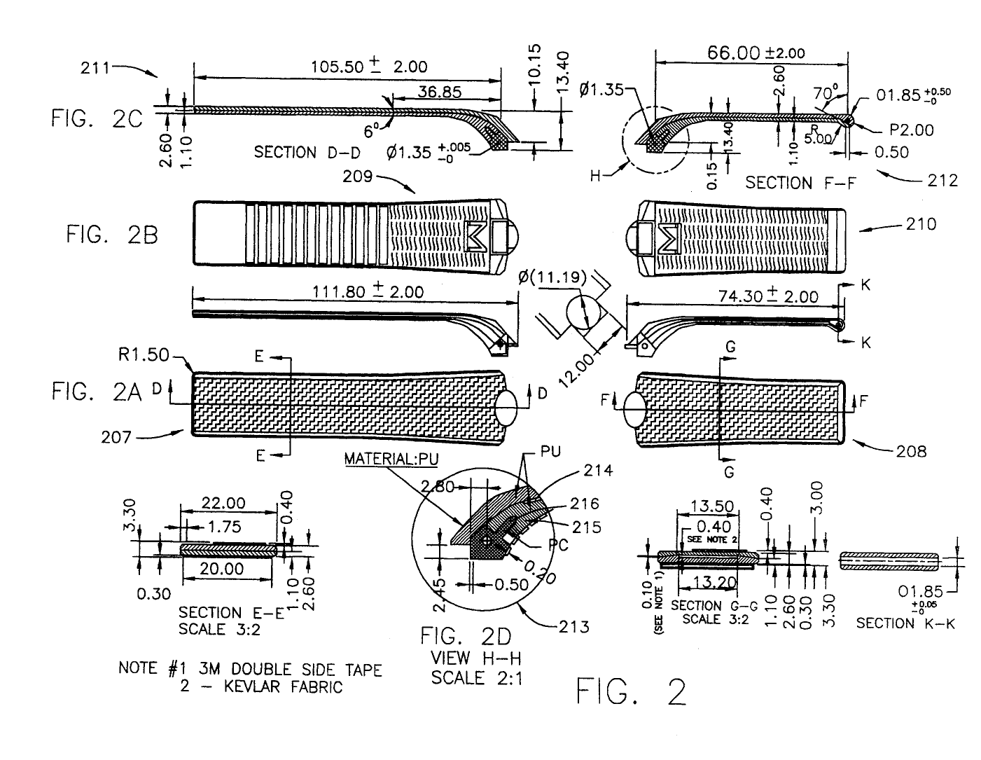

FIG. 2 includes (a) two top views (207) (208) of a strap according to an embodiment of the instant invention. These correspond to the strap right (208) and left (207) sides, with the watchcase being attached in the middle between these two sides (not shown). A surface texture reminiscent of a Kevlar® fabric weave is preferably stamped thereon, but this is for ornamental purposes and is not a necessary element. FIG. 2 (b) contains corresponding views of the strap under-sides (209) (210) (each bearing an M logo).

FIG. 2 (c) contains cross sectional views (211) and (212) of the strap sides and show the placement of the Kevlar® fabric as a solid black line running through the strap between two substrate layers. In views (211) and (212) running through the layers of substrate is the para-aramid fabric; the two layers of the substrate having been bonded intimately together by resin flowing through and around the woven fabric, resulting in a monolithic composite.

In one embodiment of the invention, the Kevlar® material runs substantially the entire length of the strap terminating at or just before where the buckle or other attachment means would unite both strap ends.

In another embodiment, the Kevlar® material extends only a portion of the strap, preferably no more than the first ⅓ to ⅕ of the strap side length so as to encompass the arc covering portions of the top and sides of a user's wrist where the watchstrap bends around close to the point of attachment to the case, at which points the greatest stresses on the watch band loop may occur. Depending on the particular watch case and band design used, it may be preferable to make adjustments to the buckle, or other attachment means, for instance making this wider, to accommodate the size and dimensions of the Kevlar® material used in the strap structure.

In another embodiment, the Kevlar® material may be applied so as to be thicker or denser at certain portions of the strap, for instance, closer to where the strap attaches to the case but terminating approximately before the pin hole region or other attachment means for the watch case (as illustrated in FIG. 2 (d), view (213), for example).

The strap may include exterior finishes to give it an appealing ornamental look, such as a shiny or a sand blasted finish, but such finishes are merely ornamental and are not necessary elements.

FIG. 2 (d), view (213), illustrates a hinge case portion for receiving a fastening pin, with a protrusion (216), with a shape akin to a nail head, reflecting an inset (216) injected into the strap to provide stability and give integration of the strap directly into the case as it turns during use while worn on a user's wrist. In FIG. 2 (d), view (213), a forked opening (215) in the substrate bottom layer accommodates protruding insert (216) at the interface between the band and the case.

In FIG. 2 (d), view (213), a terminating tip of the Kevlar® material (214) can be seen in upper right hand corner. In an embodiment, the Kevlar® material extends for approximately ⅓ to ⅕ of the strap length, or, alternatively, the Kevlar® material extends further, and may extend entire strap length, but is thicker or more dense at the portion closest to the watch case, and a thinner Kevlar® material strip extends the remainder of the strap length. The thicker or denser portion conforming approximately and proportionately to the length represented by the Kevlar® material portion shown in FIG. 2 (c).

The watchstrap is integrated into a watch and wristband system, which can be separated into four portions as applied to a user's wrist. There is the top portion that is the watch case and face. There are two side strap portions integrating the watch case at opposing sides, and then, for closure at the bottom of the wrist, there is the buckle portion or attachment means portion (the latter not shown by the figures).

In a presently preferred embodiment, a Kevlar® material strip, which may be of either a substantially uniform thickness and/or density or varying thickness and/or density over its length, reinforces each of the two straps sides over at least a portion of loop formed by the four watch band portions as they circle around a user's wrist.

In another embodiment, a Kevlar® material strip in each strap side, which may be of varying thickness and density over its length, reinforces the entire strap lengths and/or all key elements that would potentially be exposed to stress as worn on a user's wrist.

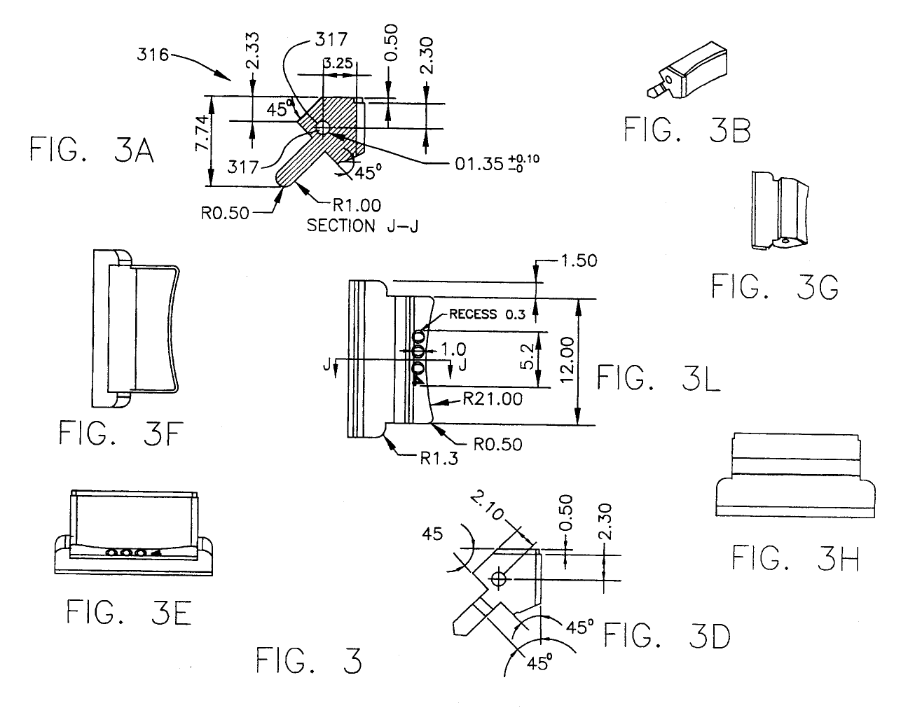

FIG. 3(a)-(h) show views of a hinging device for attaching a strap and watchcase according to an embodiment of the instant invention. In cross-section 3(a) the protruding insert (316) and pin portion (317) at the interface between the band and the case are shown. 3(c) shows a top view whereas 3(a) is a cross section of the top view. 3(b), (e), (f), (g) and (h) show views of the protruding insert at various orientations.

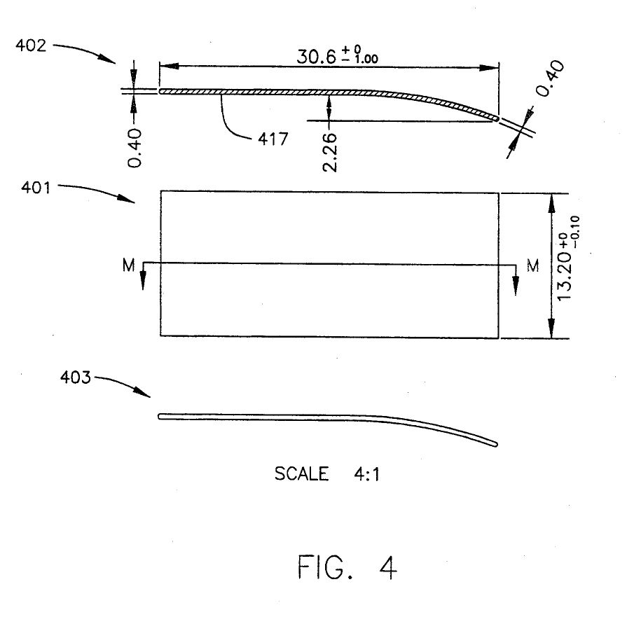

FIG. 4 illustrates a strip of Kevlar® material (417) to be integrated into a watchstrap design according to one embodiment of the invention. A top view (401) is provided, along with cross section views (402) (403). The measurements provided as to length, width, and the thickness of the Kevlar® material are examples and can be varied depending on design considerations.

The Kevlar® material may be prepared with a fabric weave which facilitates integration or adherence to a substrate surface, for instance, by providing a channel, or interstices or indentations where injected molten or liquid form substrate (Alcryn® MPR™ or other polymer material or adhesive) can permeate the Kevlar® material and thus fixate it within and/or make it integral with the resulting watchstrap structure.

The process of forming the strap structure, with Kevlar® material, may require that the thickness of the Kevlar® strip to be sufficiently thin so as not to affect the flexibility of the strap and to be accommodated without unduly thickening the strap band. The dimensions and measurements in the drawings are one example, and design considerations will dictate suitable dimensions and measurements within acceptable ranges.

Cutting of the Kevlar® insert should be very clean so as to facilitate injection and especially injection of the substrate top part. Gluing, taping or otherwise fixing of the Kevlar® insert in the band/bracelet bottom part is preferred to avoid any moving of the insert during injection of the substrate top portion.

In an exemplary fabrication process, there are 3 different injections for each section: 1) Injection of the insert in hard substrate. 2) Injection of the strap bottom part (substrate) with the cavity for the Kevlar® insert and over molding of the insert which has to be inserted in the mold. 3) Injection of the strap top substrate part after fixing (e.g. gluing) of the Kevlar® insert in the strap cavity, and over molding of the strap bottom part and insert which has to be inserted in the mold. Various views of an example of an insert are shown in FIG. 3, and in view (104) of FIG. 1.

FIG. 5 contains additional information outlining the characteristics of a presently preferred aramid narrow fabric obtained from a particular vendor for use in the watchband. It will be readily understood by those having skill in the art that other fabrics/materials may be utilized so long as the advantages of the particular fabric outlined in FIG. 5 are substantially maintained.

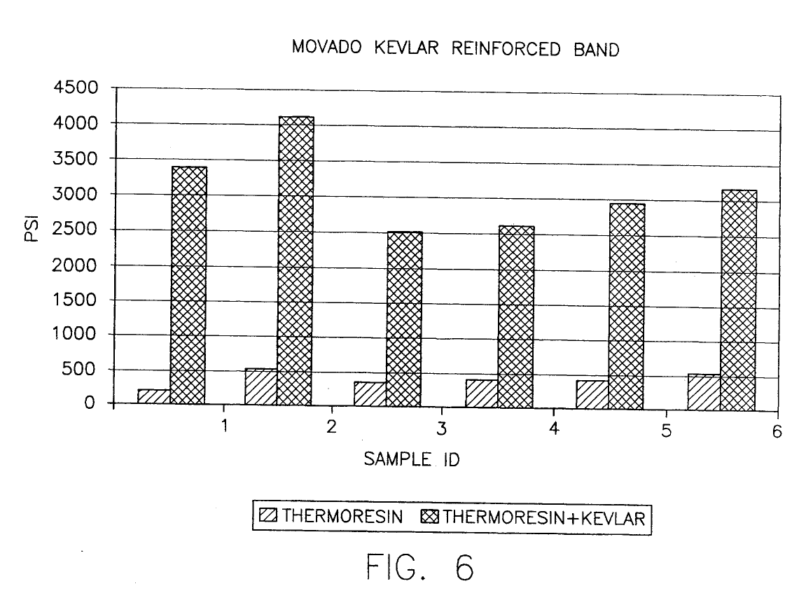

FIGS. 6-10 contain charts demonstrating the increased strength (e.g. tensile break strength) of the watchbands reinforced with the specialized fabric. The fabric reinforcing improves the tear through strength. These tests were carried out on prototype watchstraps formed of liquid cast polyurethane resin made in the same room temperature, low pressure molds. Reinforced pieces were made from the same lot of polyurethane resin with a post cure cycle to increase cross-linking of the tested straps. It should be noted that the straps under testing demonstrated greatly improved tensile break strength and generally improved total number of flex cycles to failure.

FIG. 6 contains some experimental data obtained in comparing thermoresin with and without Kevlar®. It can be seen that the reinforced thermoresin is capable of withstanding much higher PSI than thermoresin without the reinforcement.

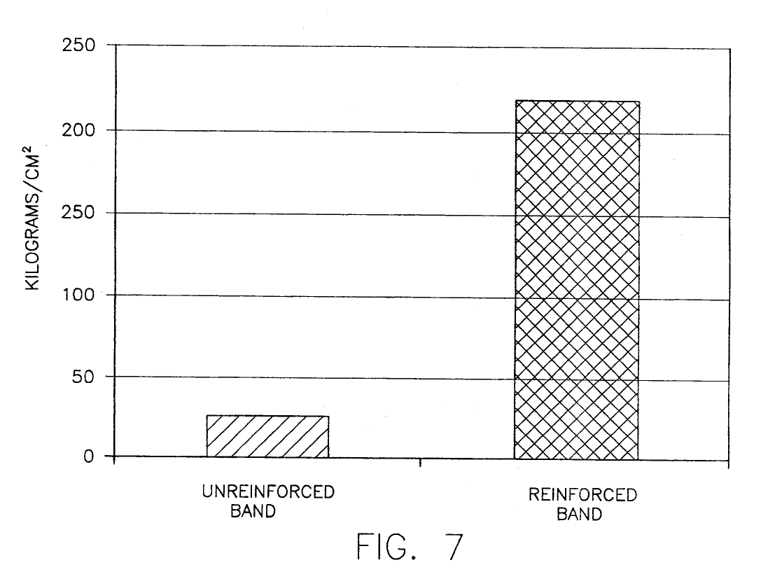

FIG. 7 contains some experimental data obtained in comparing bands with and without aramid fiber reinforcement. It can be seen that the aramid (reinforced) bands can withstand much greater weight/unit area than can bands lacking the reinforcement.

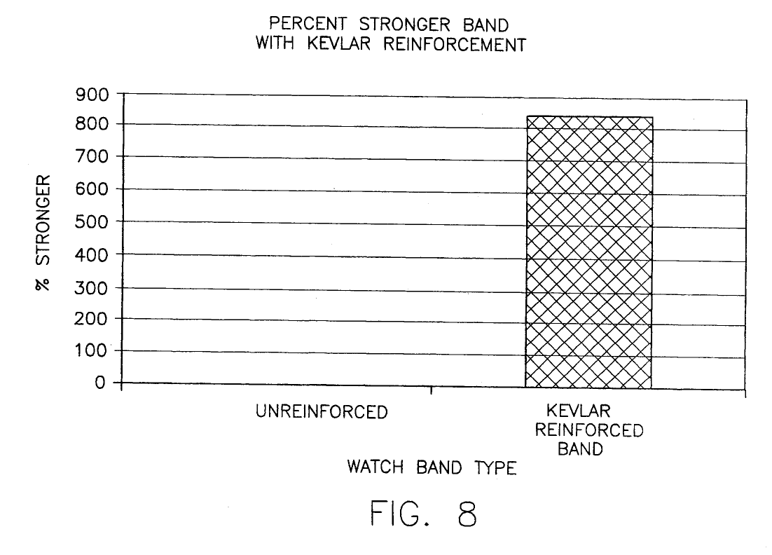

FIG. 8 contains some experimental data obtained when comparing the strength of a traditional band with a Kevlar® reinforced band. It can be readily seen that band strength is greatly improved upon reinforcement.

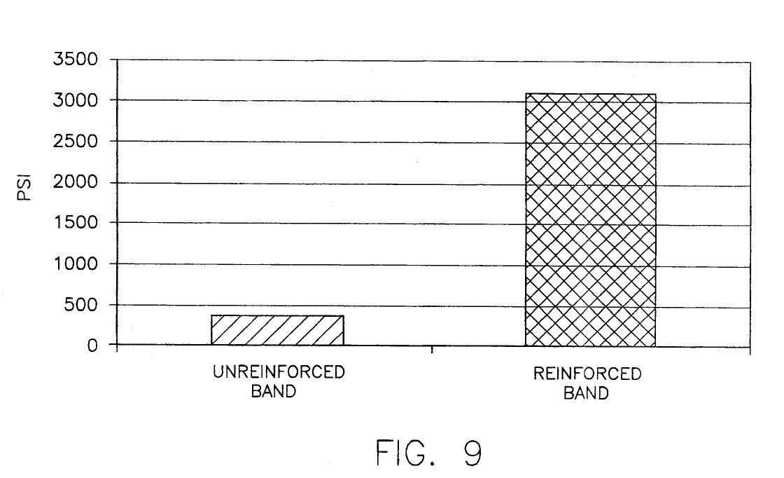

FIG. 9 contains some experimental data obtained when comparing the pressure withstood by traditional bands and bands reinforced with aramid fabric. As can be seen, the bands with reinforcement can withstand much higher pressure.

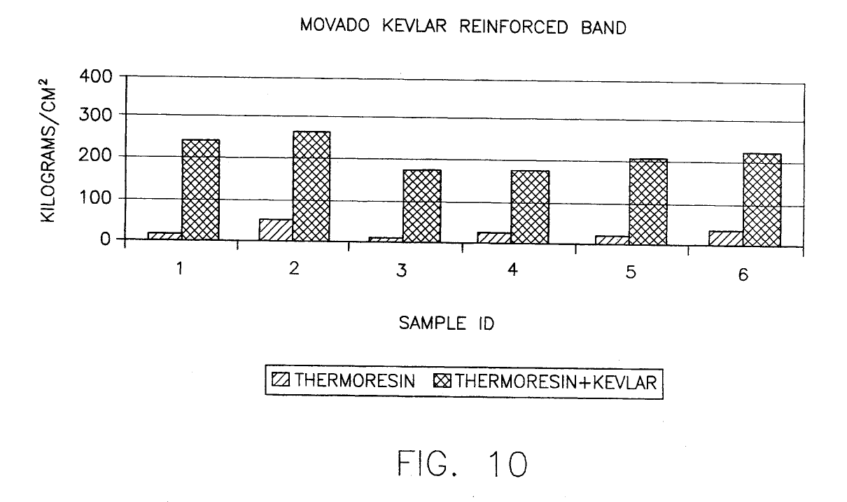

FIG. 10 contains some experimental data obtained when comparing the weight/unit area that can be tolerated by thermoresins with and without Kevlar® reinforcement. As can be seen, thermoresin without such reinforcement is weaker and cannot tolerate as much weight/unit area.

In brief recapitulation there is herein provided, by at least one embodiment of the instant invention, an integrated composite watchband having (aramid) fabric integrated therein to increase tensile strength, providing great strength and flexibility.

If not otherwise stated herein, it is to be assumed that all patents, patent applications, patent publications and other publications (including web-based publications) mentioned and cited herein are hereby fully incorporated by reference herein as if set forth in their entirety herein.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated. The Abstract, as submitted herewith, shall not be construed as being limiting upon the appended claims.

What is claimed is:

1. An integrated band comprising:
a polymer resin; and
a high tensile strength fabric;
wherein the high tensile strength fabric is integrally bonded within the polymer resin to form the integrated band.

2. The integrated band according to claim 1, wherein the high tensile strength fabric comprises a preformed narrow woven strip of aramid fabric.

3. The integrated band according to claim 1, wherein the polymer resin comprises a thermoplastic elastomer.

4. The integrated band according to claim 1, wherein the polymer resin comprises a melt processable rubber.

5. The integrated band according to claim 1, wherein a thickness of the high tensile strength fabric is uniform.

6. The integrated band according to claim 1, wherein a thickness of the high tensile strength fabric is increased in at least one portion of the integrated band.

7. The integrated band according to claim 1, wherein the high tensile strength fabric extends less than ⅓ of a total length of the integrated band.

8. The integrated band according to claim 1, wherein the high tensile strength fabric extends at least ⅓ of a total length of the integrated band.

9. The integrated band according to claim 1, wherein the integrated band has a tensile strength of at least 2000 pounds per square inch.

10. A method of forming an integrated band comprising:
providing a high tensile strength fabric within a mold;
injecting a polymer resin about the high tensile strength fabric; and
curing the polymer resin and the high tensile strength fabric mixture;
wherein the high tensile strength fabric is integrally bonded within the polymer resin via the curing.

11. The method according to claim 10, wherein the high tensile strength fabric comprises a preformed narrow woven strip of aramid fabric.

12. The method according to claim 10, wherein the polymer resin comprises a thermoplastic elastomer.

13. The method according to claim 10, wherein the polymer resin comprises a melt processable rubber.

14. The method according to claim 10, wherein a thickness of the high tensile strength fabric is uniform.

15. The method according to claim 10, wherein a thickness of the high tensile strength fabric is increased in at least one portion of the integrated band.

16. The method according to claim 10, wherein the high tensile strength fabric extends less than ⅓ of a total length of the integrated band.

17. The method according to claim 10, wherein the high tensile strength fabric extends at least ⅓ of a total length of the integrated band.

18. The method according to claim 10, wherein the integrated band has a tensile strength of at least 2000 pounds per square inch.

19. A watch comprising:
a watch case portion; and
at least one integrated band portion comprising:
a pin and hinge portion;
a polymer resin; and
a high tensile strength fabric;
wherein the high tensile strength fabric is integrally bonded within the polymer resin; and
wherein the polymer resin is molded about the pin and hinge portion to provide secure connection between the at least one integrated band portion and the watch case portion.
